(19) United States
(12) Patent Application Publication
(10) Pub. No.: US 2026/0365266 A1
(43) Pub. Date: Nov. 19, 2026

(54) RESIN COMPONENT AND VEHICLE

(71) Applicant: Kawasaki Motors, Ltd., Hyogo (JP)

(72) Inventor: Kiyotaka AKAGI, Akashi-shi (JP)

(21) Appl. No.: 19/677,530

(22) Filed: May 14, 2026

(30) Foreign Application Priority Data
May 15, 2025 (JP) 2025-082225

(51) Int. Cl. B62J 23/00; B62K 11/00

(52) U.S. Cl. CPC B62J 23/00; B62K 11/00

(57) ABSTRACT

There is provided a resin component including: a main body; a base integrated with the main body; a fixing member connected to the base in a state where a holding object is sandwiched therebetween; and a fastener configured to fix the base and the fixing member. The base includes a base engaging portion with which the fixing member is engaged and a base hole through which the fastener is inserted. The fixing member includes a member engaging portion with which the base engaging portion is engaged and a member hole through which the fastener is inserted. In a state where the fixing member and the base are connected, the member engaging portion is engaged with the base engaging portion, and in a state where the fastener is inserted into the member hole and the base hole, the fastener fixes the fixing member and the base.

### CROSS-REFERENCE TO RELATED APPLICATIONS

This application is based on and claims priority under 35 USC 119 from Japanese Patent Application No. 2025-082225 filed on May 15, 2025, the contents of which are incorporated herein by reference.

### TECHNICAL FIELD

The present disclosure relates to a resin component and a vehicle.

### BACKGROUND ART

JP3157567U discloses a fork protector applied to an inverted fork of a straddle-type vehicle. The fork protector includes a stay attachment portion to which a stay for fixing a brake hose is attached.

In JP3157567U, only bolts are illustrated as means for fixing the stay to the stay attachment portion. The bolts serve to fix the brake hose to the stay and to fix the stay to the stay attachment portion. Therefore, in a fixing work of the brake hose to the fork protector, the attachment of the brake hose to the stay and the attachment of the stay to the stay attachment portion can be performed in parallel. Therefore, the fixing work is complicated.

### SUMMARY OF INVENTION

The present disclosure provides a resin component and a vehicle that facilitate attachment of an object.

According to an illustrative aspect of the present disclosure, a resin component includes: a resin main body to be mounted on a vehicle; a base including a holding portion configured to dispose a holding object, the base being integrated with the main body; a fixing member connected to the base in a state where the holding object located in the holding portion is sandwiched between the base and the fixing member; and a fastener configured to fix the base and the fixing member to each other. The base includes a base engaging portion with which the fixing member is engaged and a base hole through which the fastener is inserted. The fixing member includes a member engaging portion with which the base engaging portion is engaged and a member hole through which the fastener is inserted. In a state where the fixing member and the base are connected to each other, the member engaging portion is engaged with the base engaging portion, and in a state where the fastener is inserted into the member hole and the base hole, the fastener fixes the fixing member and the base to each other.

### BRIEF DESCRIPTION OF DRAWINGS

FIG. 1 is a side view illustrating an example of a configuration of a vehicle according to an exemplary embodiment;

FIG. 2 is a front view of a fork guard in FIG. 1 viewed from the front;

FIG. 3 is a perspective view of the fork guard in FIG. 1 as viewed obliquely from the front;

FIG. 4 is a perspective view illustrating an example of the configuration of a line fixing portion according to the embodiment in a state where a fixing member is detached from a base;

FIG. 5 is a perspective view illustrating an example of an engagement state between the fixing member and the base of the line fixing portion according to the embodiment; and

FIG. 6 is a perspective view illustrating an example of a fitting state of the fixing member and the base of the line fixing portion according to the embodiment.

### DESCRIPTION OF EMBODIMENTS

Hereinafter, exemplary embodiments of the present disclosure will be described with reference to the drawings. The embodiments described below each show a comprehensive or specific example. Among the components in the following embodiments, ones not described in the independent claims, which define broadest concepts, will be described as optional components. Each drawing in the accompanying drawings is a schematic diagram and is not necessarily strictly illustrated. In the drawings, substantially the same components are denoted by the same reference numerals, and redundant description may be omitted or simplified.

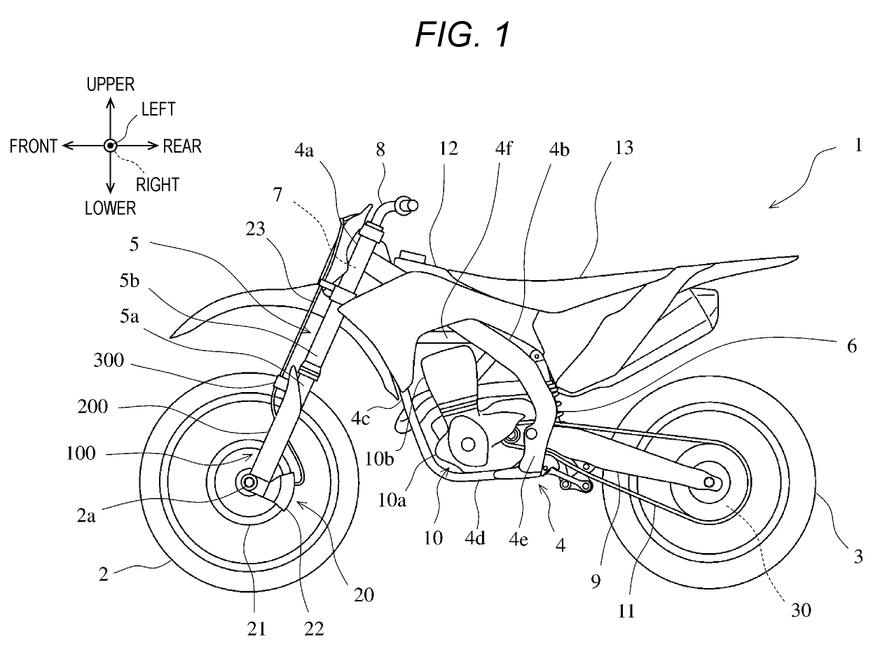

A vehicle 1 according to an exemplary embodiment will be described. FIG. 1 is a side view illustrating an example of a configuration of the vehicle 1 according to the exemplary embodiment. As illustrated in FIG. 1, the vehicle 1 according to the present embodiment is a motorcycle, specifically, a straddle-type vehicle for traveling on rough terrain. The straddle-type vehicle for traveling on rough terrain is a motocross type motorcycle on which a rider straddles and can travel on rough terrain.

In the present specification and claims, an upper direction, a lower direction, a front direction, a rear direction, a left direction, and a right direction are directions based on the vehicle 1 in a state of being disposed upright on the ground extending horizontally. The upper direction refers to a direction from the ground toward the vehicle 1, and the lower direction refers to a direction from the vehicle 1 toward the ground. The front direction refers to a forward direction of the vehicle 1. The rear direction, the left direction, and the right direction indicate corresponding directions with respect to the rider straddling the vehicle 1 standing upright on the ground.

The vehicle 1 includes a front wheel 2, a rear wheel 3, a vehicle body frame 4, a pair of left and right front forks 5 supporting the front wheel 2, and a rear suspension 6 supporting the rear wheel 3. The vehicle body frame 4 includes a head pipe 4a, a pair of left and right main frames 4b, a pair of left and right down frames 4c, a pair of left and right lower frames 4d, a pivot frame 4e, and a bridge frame 4f as frame elements. In the vehicle body frame 4, at least parts of the frame elements are joined to each other by welding.

The head pipe 4a is a tubular body having an axis in an upper-lower direction. The pair of main frames 4b extend from an upper portion of the head pipe 4a while being inclined downward and rearward. The pair of main frames 4b extend while facing each other in the left-right direction so as to be separated from each other in the left-right direction as being separated from the head pipe 4a. The pair of down frames 4c extend downward and rearward from a lower portion of the head pipe 4a at positions below the pair of main frames 4b, respectively. The pair of down frames 4c extend while facing each other in the left-right direction so as to be separated from each other in the left-right direction as being separated from the head pipe 4a. The lower frames 4d extend downward from lower portions of the down frames 4c, respectively, and then curve and extend rearward. The pivot frame 4e connects rear portions of the main frames 4b to rear portions of the lower frames 4d, respectively. The bridge frame 4f connects the main frame 4b and the down frame 4c in a gusset shape on each of a left side and a right side of the vehicle 1.

The vehicle 1 includes a steering shaft 7 and handlebars 8. The steering shaft 7 is rotatably inserted into the head pipe 4a. The handlebars 8 are attached to an upper bracket attached to an upper portion of the steering shaft 7. Upper portions of the pair of front forks 5 are connected to the upper bracket and an under bracket that are respectively attached to the upper portion and a lower portion of the steering shaft 7. The pair of front forks 5 are located on the left and right sides of the steering shaft 7, respectively. Lower portions of the pair of front forks 5 rotatably support the front wheel 2 from outside in the left-right direction. When the rider turns the handlebar 8, the front wheel 2 is steered via the steering shaft 7 and the front forks 5.

The vehicle 1 includes a swing arm 9 extending in the front-rear direction. A front portion of the swing arm 9 is pivotally supported by the pivot frame 4e. A rear portion of the swing arm 9 rotatably supports the rear wheel 3, which is a drive wheel. The rear suspension 6 is connected to the swing arm 9 and an upper portion of the pivot frame 4e.

The vehicle 1 includes a drive source 10 in a space surrounded by the vehicle body frame 4. The drive source 10 is fixed to the vehicle body frame 4. In the present embodiment, the drive source 10 is an internal combustion engine.

The internal combustion engine 10 is a reciprocating engine. The internal combustion engine 10 includes a crankcase 10a and a cylinder block 10b extending upward from an upper portion of the crankcase 10a. The cylinder block 10b includes one or more cylinder bores, and a piston is slidably accommodated in each of the cylinder bores. The crankcase 10a includes a crankshaft connected to the piston via a connecting rod. The internal combustion engine 10 generates power by repeating combustion and explosion of a mixture of fuel gas and air in the cylinder bores. The internal combustion engine 10 converts reciprocating motion of the piston due to the combustion and explosion into rotational motion of the crankshaft, and transmits the rotational power of the crankshaft to the rear wheel 3 via a power transmission member 11 such as a chain or a belt.

The vehicle 1 includes a fuel tank 12 in a space between the pair of main frames 4b. The fuel tank 12 is supported by the pair of main frames 4b. The vehicle 1 includes a seat 13 on which a rider straddles behind the fuel tank 12.

The vehicle 1 includes a brake device 20 for the front wheel 2 and a brake device 30 for the rear wheel 3. The brake device 20 includes a brake disc 21, a brake caliper 22, and a brake line 23. The brake disc 21 has a disc shape, is mounted on the front wheel 2, and rotates integrally with the front wheel 2. The brake caliper 22 is mounted on the front fork 5 and is immovable with respect to a rotation center axis of the front wheel 2. The brake caliper 22 is disposed so as to sandwich left and right disc surfaces of the brake disc 21 from left and right outer sides. The brake caliper 22 includes a brake pad, which is a friction material located to face the disc surfaces of the brake disc 21, and a piston, which moves the brake pad toward one of the disc surfaces of the brake disc 21. The brake caliper 22 extends the piston by hydraulic pressure supplied via the brake line 23 to press the brake pad against the brake disc 21.

The brake line 23 extends from the brake caliper 22 to the handlebar 8 along the front fork 5 and is connected to a master cylinder located on the handlebar 8. The brake line 23 is filled with a brake fluid. The master cylinder operates to apply pressure to the brake fluid in the brake line 23.

The vehicle 1 includes fork guards 100 on the front forks 5. The fork guards 100 are attached to the left and right front forks 5, respectively, and extend upward along the front forks 5 from the vicinity of an axle 2a of the front wheel 2.

The fork guard 100 includes a resin main body 200 mounted on the front fork 5 and a line fixing portion 300 located on the main body 200. The line fixing portion 300 supports the brake line 23. The main body 200 covers at least the front of the front fork 5, and also covers a side of the front fork 5 in the present embodiment. In the present embodiment, the front fork 5 is attached to the vehicle 1 such that an inner tube 5a is located below an outer tube 5b. The main body 200 covers at least the inner tube 5a. In the present embodiment, the main body 200 has a partially cylindrical shape, which is a part of a cylinder in a circumferential direction.

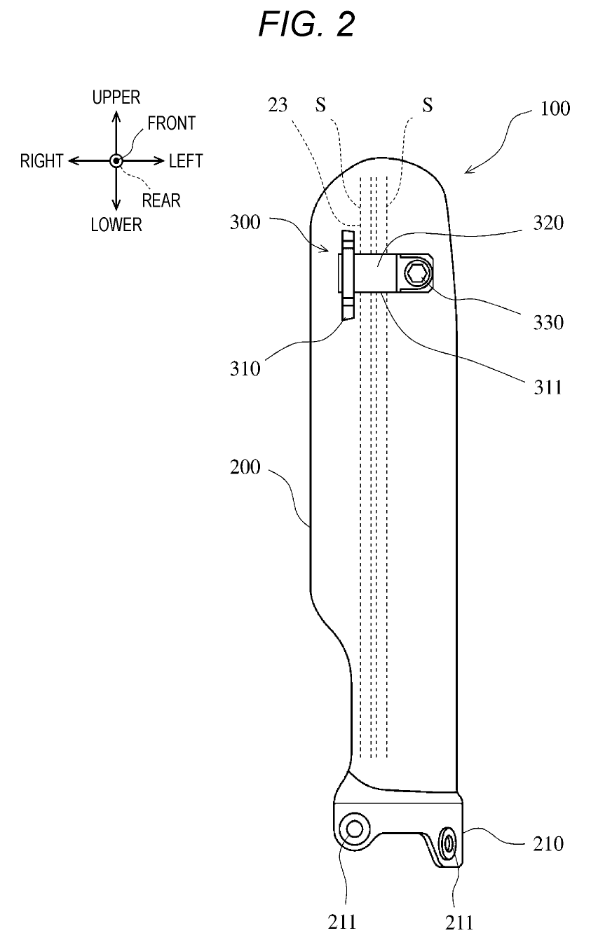

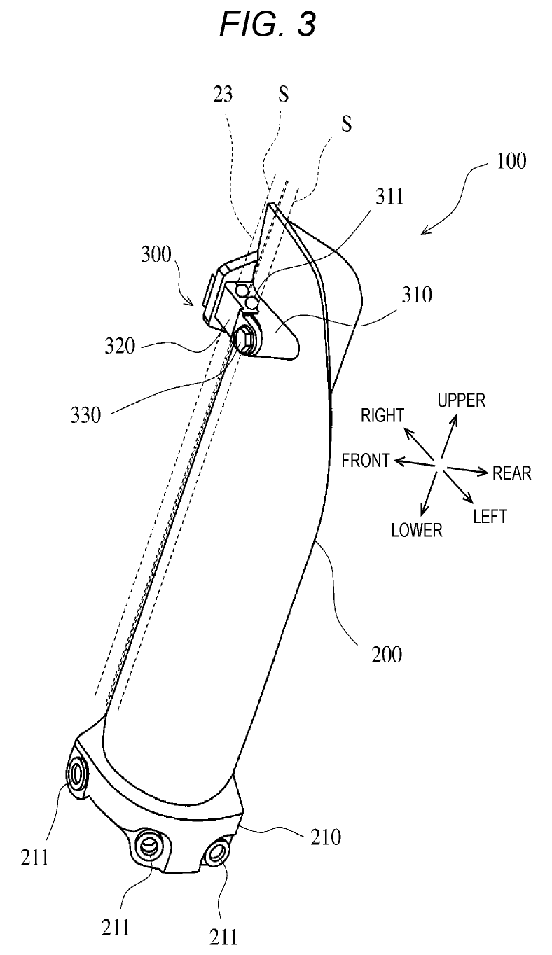

FIG. 2 is a front view of the fork guard 100 in FIG. 1 viewed from the front. FIG. 3 is a perspective view of the fork guard 100 in FIG. 1 as viewed obliquely from the front. The fork guard 100 illustrated in FIGS. 2 and 3 has a structure mounted on the left front fork 5. The fork guard 100 has a structure of covering the left front fork 5 from the front and the left in a state of being mounted on the left front fork 5. As illustrated in FIGS. 2 and 3, the main body 200 includes an attachment portion 210 at a lower portion thereof. The attachment portion 210 includes a plurality of attachment holes 211. The attachment portion 210 is fixed to the front fork 5 by bolts inserted into the attachment holes 211.

The line fixing portion 300 includes a base 310, a fixing member 320, and a fastener 330. The base 310 is integrated with the main body 200. In the present embodiment, the base 310 is made of a resin and includes the same resin material as the main body 200. For example, the base 310 is integrated with the main body 200 by being integrally molded with the main body 200. The main body 200 and the base 310 are integrally molded.

The base 310 includes a base holding portion 311 on which holding objects S are disposed. The base holding portion 311 can hold one or more holding objects S, and can hold two holding objects S in the present embodiment. In the present embodiment, the holding object S is the brake line 23. Since the vehicle 1 includes one brake line 23 for the brake device 20 of the front wheel 2, the base holding portion 311 holds one brake line 23 by using a part of a holding capacity. The fixing member 320 is connected to the base 310 in a state where the brake line 23 located in the base holding portion 311 is sandwiched between the fixing member 320 and the base 310. The fastener 330 fixes the base 310 and the fixing member 320 to each other. In the present embodiment, the fastener 330 is a bolt.

In the present embodiment, the vehicle 1 includes the brake disc 21 and the brake caliper 22 only on a left side of the front wheel 2. The base holding portion 311 holds the brake line 23 extending from the brake caliper 22 on the left side of the front wheel 2. Therefore, the fork guard 100 mounted on the right front fork 5 may not include the line fixing portion 300. For example, when the vehicle 1 includes the brake discs 21 and the brake calipers 22 on both the left and right sides of the front wheel 2, both the fork guards 100 of the left and right front forks 5 may include the line fixing portions 300.

A fixing part of the fastener 330 on the base 310 is at a position on the base 310 that is biased outward in a vehicle width direction of the vehicle 1. Specifically, the fixing part of the fastener 330 is located further outward than the base holding portion 311 in the vehicle width direction of the vehicle 1. Since the fork guard 100 is mounted on the left front fork 5, the outer side of the vehicle 1 in the vehicle width direction is the left side of the vehicle 1. In the present embodiment, since the vehicle 1 is a straddle-type vehicle for traveling on rough terrain, the fork guard 100 may come into contact with an obstacle. Further, when the vehicle 1 is used in a competition, the fork guard 100 may come into contact with another vehicle. The fastener 330 can guard the brake line 23 from an obstacle or another vehicle by locating the fixing part of the fastener 330 on the base 310 outward in the vehicle width direction of the vehicle 1. Accordingly, the brake line 23 can be stably held by the line fixing portion 300.

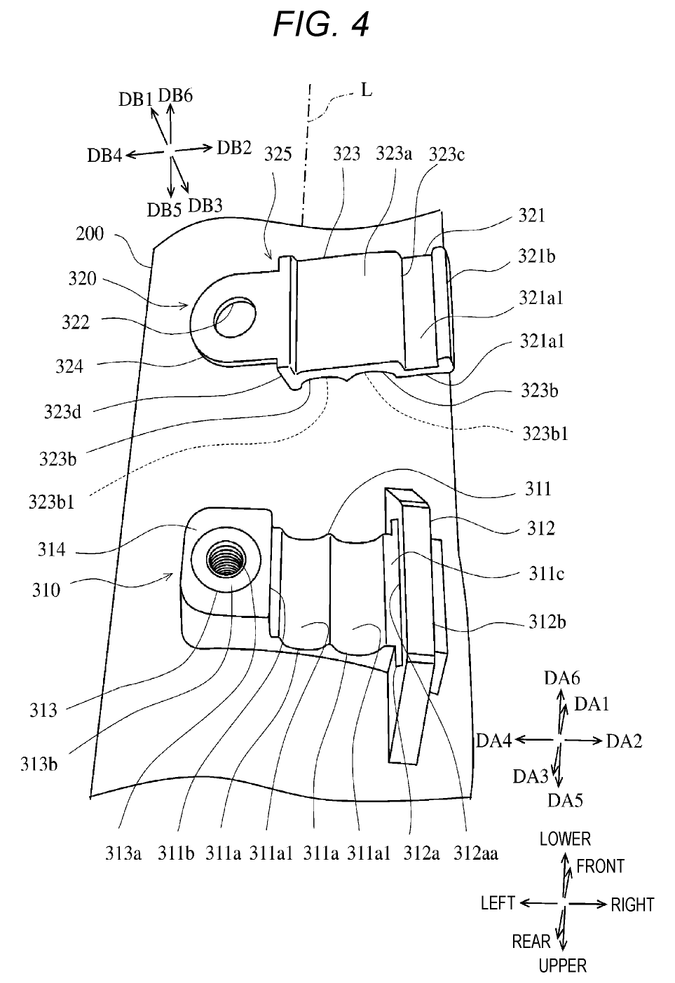

FIG. 4 is a perspective view illustrating an example of the configuration of the line fixing portion 300 according to the embodiment in a state where the fixing member 320 is detached from the base 310. As illustrated in FIG. 4, the base 310 further includes a base engaging portion 312 with which the fixing member 320 is engaged, a base hole 313 through which the fastener 330 is inserted, and a receiving surface 314 on which a part of the fixing member 320 is placed. The base holding portion 311 is located between the base engaging portion 312 and the receiving surface 314. The base hole 313 opens on the receiving surface 314. The receiving surface 314 faces a direction DA1 from the main body 200 toward the base 310.

Here, six directions based on the base 310 are referred to as directions DA1 to DA6. The direction DA1 is a direction from the main body 200 toward the base 310. The direction DA3 is a direction from the base 310 toward the main body 200. The direction DA3 is also a direction opposite to the direction DA1. The direction DA2 is a direction from the base hole 313 toward the base engaging portion 312. The direction DA2 is also a direction intersecting the directions DA1 and DA3, and is also a direction intersecting a direction in which the brake line 23 disposed in the base holding portion 311 extends. The direction DA4 is a direction from the base engaging portion 312 toward the base hole 313. The direction DA4 is also a direction opposite to the direction DA2. The direction DA5 is a direction along a cylindrical axis L of the partially cylindrical main body 200. The direction DA5 is also a direction intersecting the directions DA1 to DA4.

In the present embodiment, the direction DA6 is opposite to the direction DA5. The direction DA1 corresponds to the front direction, the direction DA3 corresponds to the rear direction, the direction DA2 corresponds to the right direction, the direction DA4 corresponds to the left direction, the direction DA5 corresponds to the upper direction, and the direction DA6 corresponds to the lower direction.

The base hole 313 extends from the receiving surface 314 in the direction DA3 and opens in the direction DA1. In the present embodiment, the base hole 313 is a non-through hole, but may be a through hole penetrating the base 310 and the main body 200. The base hole 313 includes a female thread 313a on an inner peripheral surface thereof. In the present embodiment, the base 310 includes a cylindrical collar 313b in the base hole 313. The collar 313b contains a material having a higher strength than the base 310, and contains a metal material in the present embodiment. The collar 313b is integrated with the base 310. For example, the collar 313b can be embedded in the base 310 by a resin molding method such as insert molding. The collar 313b includes the female thread 313a on an inner peripheral surface of a through hole penetrating the collar 313b. The female thread 313a may be directly formed in a resin portion of the inner peripheral surface of the base hole 313.

The base holding portion 311 has a shape recessed in the direction DA3 from the receiving surface 314. The base holding portion 311 includes surrounding portions 311a located at the bottom of the recess and a fitting wall surface 311b located in the direction DA4 with respect to the surrounding portion 311a. The base holding portion 311 is a portion extending from the fitting wall surface 311b to the base engaging portion 312 in the direction DA2.

In the present embodiment, the base holding portion 311 includes two surrounding portions 311a disposed in the direction DA2. The surrounding portion 311a is recessed in the direction DA3 and includes a partially cylindrical curved surface 311a1 conforming to an outer peripheral surface of the brake line 23. The direction of a cylindrical axis of the curved surface 311a1 is the direction DA5. The surrounding portion 311a surrounds a circumferential portion of the brake line 23 disposed on the curved surface 311a1. The surrounding portion 311a determines the position of the brake line 23 disposed on the curved surface 311a1 of the surrounding portion 311a in the direction DA2, and directs the brake line 23 to extend in the direction DA5.

For example, when two holding objects S such as the brake line 23 are disposed on the curved surfaces 311a1 of the two surrounding portions 311a, the two surrounding portions 311a position the two holding objects S such that the two holding objects S extend in the direction DA5 and are spaced apart in the direction DA2. The surrounding portion 311a has a function of positioning the holding object S such as the brake line 23.

The fitting wall surface 311b extends in the direction DA3 from an edge of the receiving surface 314 in the direction DA2. The fitting wall surface 311b is located to face the base engaging portion 312 in the direction DA2. The fitting wall surface 311b faces the direction DA2.

The base engaging portion 312 extends from the main body 200 in the direction DA1. The base engaging portion 312 protrudes in the direction DA1 from the base holding portion 311. The base engaging portion 312 includes a through hole 312a penetrating a protruding portion thereof in the direction DA2. In the present embodiment, a cross-sectional shape of the through hole 312a viewed from the direction DA2 is rectangular. The through hole 312a has a shape and a size into which an end portion of the fixing member 320 can be inserted. The through hole 312a is adjacent to the base holding portion 311 in the direction DA2. The height position of a top wall surface 312aa of the through hole 312a in the direction DA1 is higher than the height position of an upper surface 311c of the base holding portion 311 in the direction DA1. The upper surface 311c is adjacent to the surrounding portion 311a in the direction DA2.

The base engaging portion 312 includes a base blocking portion 312b including the top wall surface 312aa of the through hole 312a. The base blocking portion 312b is located in the direction DA1 with respect to the top wall surface 312aa. The base blocking portion 312b extends in the direction DA5.

In the present embodiment, the base engaging portion 312 has a frame shape surrounding the through hole 312a. The base blocking portion 312b is a portion of the frame-shaped portion of the base engaging portion 312 that is located in the direction DA1, and has a columnar shape extending in the direction DA5.

The fixing member 320 includes a resin material. In the present embodiment, the fixing member 320 includes the same resin material as the base 310. The fixing member 320 has a plate shape and has flexibility. The fixing member 320 includes a member engaging portion 321 that is engaged with the base engaging portion 312, and a member hole 322 through which the fastener 330 is inserted. The fixing member 320 includes a member holding portion 323 that holds the brake line 23 together with the base holding portion 311 between the member engaging portion 321 and the member hole 322.

The fixing member 320 includes a fixing portion 324 where the member hole 322 is located. The fixing portion 324 has a plate shape. The member hole 322 penetrates the fixing portion 324 in a plate thickness direction. The plate thickness direction of the fixing portion 324 is along directions DB1 and DB3 to be described below. In a state where the fixing member 320 is assembled to the base 310, the fixing portion 324 is placed on the receiving surface 314 of the base 310, and the member hole 322 is aligned with the base hole 313. The fixing member 320 is fixed to the base 310 by the fastener 330 inserted into the member hole 322 and the base hole 313. In the present embodiment, the fixing member 320 is fixed to the base 310 by a fastener 330 that is screwed into the base hole 313 through the member hole 322.

Here, the six directions based on the fixing member 320 are referred to as directions DB1 to DB6. The direction DB1 is a direction in which the member hole 322 penetrates the fixing portion 324. In the present embodiment, in the state where the fixing member 320 is assembled to the base 310, the direction DB1 is also a direction from the base hole 313 toward the member hole 322, and corresponds to the direction DA1 and the front direction. The direction DBb is a direction in which the member hole 322 penetrates the fixing portion 324, and is a direction opposite to the direction DB1. In the present embodiment, in the state where the fixing member 320 is assembled to the base 310, the direction DB3 corresponds to the direction DA3 and the rear direction.

The direction DB2 is a direction from the member hole 322 toward the member engaging portion 321. The direction DB2 is also a direction intersecting the directions DB1 and DB3. In the present embodiment, in the state where the fixing member 320 is assembled to the base 310, the direction DB2 corresponds to the direction DA2 and the right direction. The direction DB4 is a direction from the member engaging portion 321 toward the member hole 322 and is a direction opposite to the direction DB2. In the present embodiment, in the state where the fixing member 320 is assembled to the base 310, the direction DB4 corresponds to the direction DA4 and the left direction.

The direction DB5 is a direction in which surrounding portions 323b of the member holding portion 323 extend, and is a direction intersecting the directions DB1 to DB4. The direction DB6 is a direction opposite to the direction DB5. In the present embodiment, in the state where the fixing member 320 is assembled to the base 310, the direction DB5 corresponds to the direction DA5 and the upper direction, and the direction DB6 corresponds to the direction DA6 and the lower direction.

The member holding portion 323 has a plate shape extending from the fixing portion 324 in the direction DB2. The plate thickness direction of the member holding portion 323 is along the directions DB1 and DB3. The member holding portion 323 includes a surface 323a facing the direction DB1.

The member holding portion 323 includes the surrounding portions 323b in portions opposite to the surface 323a. In the present embodiment, the member holding portion 323 includes two surrounding portions 323b arranged in the direction DB2. The surrounding portion 323b is recessed in the direction DB1, and includes a partially cylindrical curved surface 323b1 conforming to the outer peripheral surface of the brake line 23. The surrounding portion 323b surrounds a circumferential portion of the brake line 23 located on the curved surface 323b1. The surrounding portion 323b determines the position of the brake line 23 disposed on the curved surface 323b1 of the surrounding portion 323b in the direction DB2, and directs the brake line 23 to extend in a cylindrical axis direction of the curved surface 323b1.

For example, when two holding objects S such as the brake line 23 are disposed on the curved surfaces 323b1 of the two surrounding portions 323b, the two surrounding portions 323b position the two holding objects S such that the two holding objects S extend in the cylindrical axis direction of the curved surfaces 323b1 and are spaced apart in the direction DB2. The surrounding portion 323b has a function of positioning the holding object S such as the brake line 23. In the present embodiment, the cylindrical axis direction of the curved surface 323b1 is a direction perpendicular to the direction DB2.

The member engaging portion 321 includes a contact portion 321a and a member blocking portion 321b. The contact portion 321a extends from the member holding portion 323 in the direction DB2. The contact portion 321a also extends in the direction DB5. The member blocking portion 321b extends from the contact portion 321a in a direction intersecting the direction DB2, and in the present embodiment, extends in the directions DB1 and DB5. The contact portion 321a is located to be shifted stepwise in the direction DB3 with respect to the member holding portion 323. The contact portion 321a includes a surface 321a1 facing the direction DB1. The surface 321a1 of the contact portion 321a is located in the direction DB3 with respect to the surface 323a of the member holding portion 323. Accordingly, the surface 321a1 and the surface 323a form a step. The member engaging portion 321 has a hook shape.

The member holding portion 323 includes a first fitting surface 323c between the surface 323a and the surface 321a1. The first fitting surface 323c extends in the directions DB1 and DB5 between the surface 323a and the surface 321a1 and faces the direction DB2. The first fitting surface 323c is adjacent to the member engaging portion 321 in the direction DB2. The member holding portion 323 includes a second fitting surface 323d adjacent to the fixing portion 324 in the direction DB4. The second fitting surface 323d extends in the directions DB1 and DB5 and faces the direction DB4. In the present embodiment, the fixing member 320 includes the fitting surfaces 323c and 323d as a fitting portion 325. The member holding portion 323 includes two surrounding portions 323b between the fitting surfaces 323c and 323d.

An example of a method of fixing the brake line 23 to the line fixing portion 300 will be described. As illustrated in FIG. 4, one brake line 23 is disposed in the base holding portion 311 of the base 310 in a state where the fixing member 320 is detached. Next, the member blocking portion 321b of the member engaging portion 321 of the fixing member 320 is inserted into the through hole 312a of the base engaging portion 312 in the direction DA2.

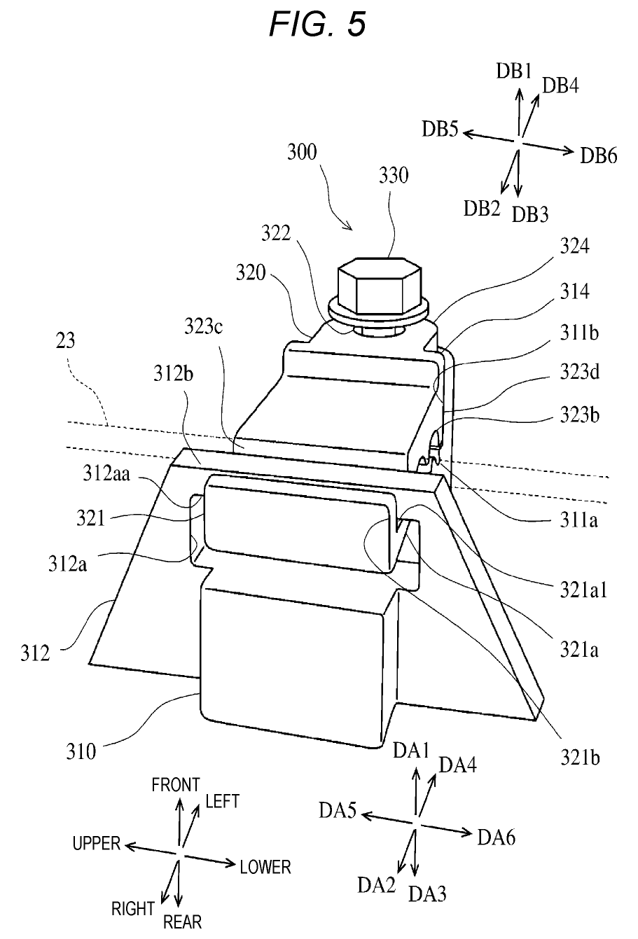

Further, as illustrated in FIG. 5, the base blocking portion 312b of the base engaging portion 312 is fitted between the member blocking portion 321b of the member engaging portion 321 of the fixing member 320 and the first fitting surface 323c. FIG. 5 is a perspective view illustrating an example of an engagement state between the fixing member 320 and the base 310 of the line fixing portion 300 according to the embodiment. The member blocking portion 321b is engaged with the base blocking portion 312b to block the movement of the fixing member 320 in the direction DA4 with respect to the base 310. The base blocking portion 312b blocks the movement of the fixing member 320 in the direction DA1 with respect to the base 310 by bringing the top wall surface 312aa into contact with the surface 321a1 of the contact portion 321a of the fixing member 320. For example, the fixing member 320 may receive a reaction force in the direction DA1 from the brake line 23 when sandwiching the brake line 23 together with the base 310. However, the contact blocks the movement of the fixing member 320 due to the reaction force. The member blocking portion 321b and the base blocking portion 312b block the movement of the fixing member 320 with respect to the base 310 in the direction in which the engagement between the member engaging portion 321 and the base engaging portion 312 is released.

Further, the fixing member 320 is rotated about the base blocking portion 312b while the member engaging portion 321 and the base engaging portion 312 are engaged with each other. The fixing member 320 is rotated such that the fixing portion 324 approaches the receiving surface 314 of the base 310. In the process of rotation, the brake line 23 is sandwiched and positioned between the surrounding portions 311a of the base holding portions 311 and the surrounding portions 323b of the member holding portions 323 corresponding to each other. When the attachment of the fixing member 320 to the base 310 is completed, the two surrounding portions 311a face the two surrounding portions 323b, respectively. The surrounding portion 311a and the surrounding portion 323b corresponding to each other face each other after the attachment of the fixing member 320 is completed.

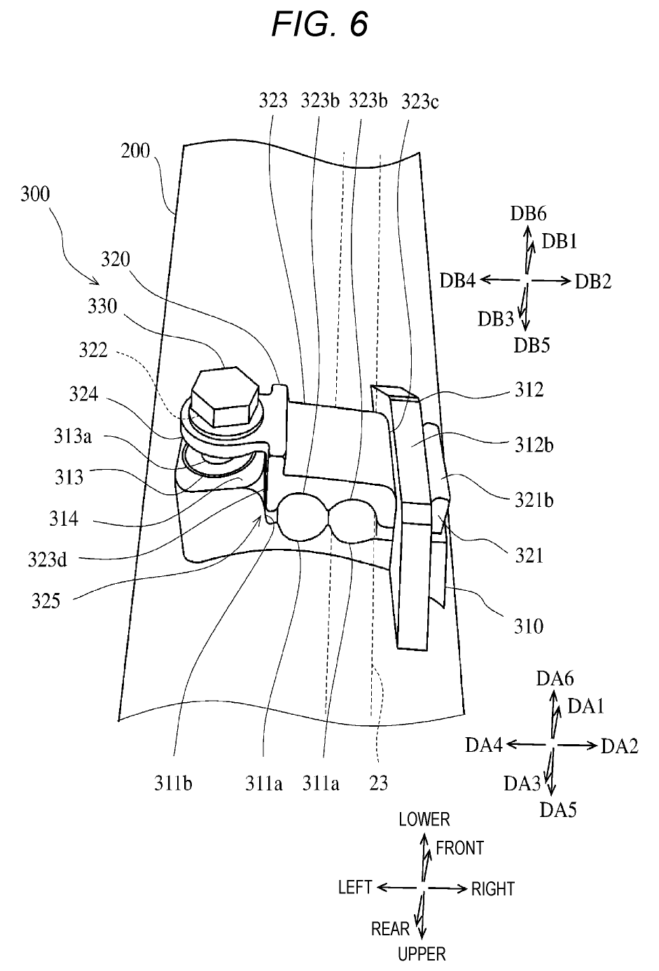

As illustrated in FIG. 6, the fitting portion 325 of the fixing member 320 is fitted between the fitting wall surface 311b of the base 310 and the base engaging portion 312, and is fitted to the fitting wall surface 311b and the base engaging portion 312. FIG. 6 is a perspective view illustrating an example of a fitting state of the fixing member 320 and the base 310 of the line fixing portion 300 according to the embodiment. In the present embodiment, a distance between the first fitting surface 323c and the second fitting surface 323d of the fitting portion 325 is equal to or slightly larger than a distance between the fitting wall surface 311b and the base engaging portion 312. Since the fixing member 320 has flexibility, fitting of the fitting portion 325 is easy. Since the fixing member 320 is temporarily fixed to the base 310 by the fitting of the fitting portion 325, the fixing member 320 can be prevented from falling off from the base 310 until a fixing work of the fixing member 320 using the fastener 330 is completed.

Further, the member hole 322 of the fixing member 320 is aligned with the base hole 313 of the base 310. Further, the fastener 330 is inserted and screwed into the member hole 322 and the base hole 313, and is screwed into the female thread 313a of the base hole 313. Accordingly, the fixing portion 324, which is an end portion of the fixing member 320 in the direction DB4, is fixed to the receiving surface 314 of the base 310 by the fastener 330. The member engaging portion 321, which is an end portion of the fixing member 320 in the direction DB2, can maintain the engagement with the base engaging portion 312 by the engagement between the base blocking portion 312b and the member blocking portion 321b. Since the fixing member 320 is temporarily fixed to the base 310 by the engagement between the member engaging portion 321 and the base engaging portion 312 and the fitting of the fitting portion 325, the insertion and fastening work of the fastener 330 is easy. When the fastening of the fastener 330 is completed, the fixing member 320 is fixed to the base 310 at both end portions in the directions DB2 and DB4.

Although the exemplary embodiments of the present disclosure have been described above, the present disclosure is not limited to the above embodiment. That is, various modifications and improvements can be made within the scope of the present disclosure. For example, various modifications to the embodiments and forms constructed by combining components in different embodiments are also included in the scope of the present disclosure.

For example, in the line fixing portion 300 according to the embodiment, the base 310 is integrated with the main body 200 using the same resin material as the main body 200 of the fork guard 100, but the structure of the base 310 is not limited thereto. For example, the base 310 may include a material different from that of the main body 200, such as metal. The base 310 may be integrated with the main body 200 by a resin molding method such as insert molding. The base 310 may be integrated with the main body 200 by means of adhesion, welding, fitting, engagement, caulking, or the like. The base 310 may be integrated with the main body 200 by fastening means such as bolts or rivets.

In the embodiment, in the line fixing portion 300, the base hole 313 of the base 310 has the female thread 313a, and the member hole 322 of the fixing member 320 is a through hole, but the configuration of the base hole 313 and the member hole 322 is not limited thereto. For example, the member hole 322 may have a female thread and the base hole 313 may be a through hole, or the base hole 313 and the member hole 322 may be through holes, and a male threaded shaft of the fastener 330 penetrating the base hole 313 and the member hole 322 may be fastened to a nut outside the base hole 313 or the member hole 322.

The line fixing portion 300 according to the embodiment includes a bolt as the fastener 330, but the fastener 330 is not limited thereto. For example, the fastener 330 may have a structure that is inserted into the base hole 313 of the base 310 and the member hole 322 of the fixing member 320 to fix the fixing member 320 to the base 310. Examples of the fastener 330 may include a pin such as a lock pin, a clip such as a rivet clip, and a rivet.

The line fixing portion 300 according to the embodiment includes the base engaging portion 312 and the fitting wall surface 311b as a fitting portion in the base 310, and includes the fitting surfaces 323c and 323d as the fitting portion 325 in the fixing member 320. The fixing member 320 is assembled to the base 310 by fitting the fitting surfaces 323c and 323d to the base engaging portion 312 and the fitting wall surface 311b. However, a fitting structure of the fixing member 320 and the base 310 is not limited to the above. The fixing member 320 may be assembled to the base 310 by fitting the fitting surface 323c or 323d to the base engaging portion 312 or the fitting wall surface 311b. For example, the fixing member 320 may not include the fitting surface 323d, and the base 310 may not include the fitting wall surface 311b. The fixing member 320 can be held by the base 310 by fitting the fitting surface 323c to the base engaging portion 312.

In the embodiment, the fork guard 100 is exemplified as an application target of the line fixing portion 300, but the application target of the line fixing portion 300 may be any component or member of the vehicle 1.

In the embodiment, the brake line 23 is exemplified as the holding object S of the line fixing portion 300, but the holding object S of the line fixing portion 300 may be any component of the vehicle 1. For example, the holding object S of the line fixing portion 300 may be a linear object such as wiring, a cable, a clutch hose, a cooling water line, another liquid line, or an air line of the vehicle 1. The line fixing portion 300 may hold a linear object of the vehicle 1 other than the brake line 23 by using a pair of the surrounding portion 311a of the base 310 and the surrounding portion 323b of the fixing member 320 corresponding to each other. The line fixing portion 300 may hold the brake line 23 and the linear object of the vehicle 1 other than the brake line 23 by using two pairs of the surrounding portion 311a and the surrounding portion 323b, or may hold two of the linear objects of the vehicle 1 including the brake line 23.

In the embodiment, the line fixing portion 300 includes two pairs of the surrounding portion 311a of the base 310 and the surrounding portion 323b of the fixing member 320 and is configured to hold two holding objects S, but the number of holding objects S that can be held by the line fixing portion 300 is not limited to two. The line fixing portion 300 may include only one pair of the surrounding portion 311a of the base 310 and the surrounding portion 323b of the fixing member 320 and may be configured to hold one holding object S. The line fixing portion 300 may include three or more pairs of the surrounding portion 311a of the base 310 and the surrounding portion 323b of the fixing member 320 and may be configured to hold three or more holding objects S.

In the embodiment, a motorcycle is exemplified as the vehicle 1 to which the line fixing portion 300 is applied, but the line fixing portion 300 may be applied to any vehicle.

In the embodiment, the drive source 10 of the vehicle 1 is an internal combustion engine, but is not limited thereto. The drive source 10 may be an electric motor or a combination of the electric motor and the internal combustion engine.

Examples of aspects of the technology of the present disclosure will be described below. A resin component according to a first aspect of the present disclosure includes: a resin main body to be mounted on a vehicle; a base including a holding portion configured to dispose a holding object, the base being integrated with the main body; a fixing member connected to the base in a state where the holding object located in the holding portion is sandwiched between the base and the fixing member; and a fastener configured to fix the base and the fixing member to each other. The base includes a base engaging portion with which the fixing member is engaged and a base hole through which the fastener is inserted. The fixing member includes a member engaging portion with which the base engaging portion is engaged and a member hole through which the fastener is inserted. In a state where the fixing member and the base are connected to each other, the member engaging portion is engaged with the base engaging portion, and in a state where the fastener is inserted into the member hole and the base hole, the fastener fixes the fixing member and the base to each other.

According to the first aspect, the base and the fixing member sandwich and hold the holding object therebetween in a state of being connected to each other. The connection between the base and the fixing member is implemented by the engagement between the base engaging portion and the member engaging portion and the fastening of the fastener to the base hole and the member hole. Therefore, the holding object is disposed in the holding portion of the base, the base engaging portion and the member engaging portion are engaged with each other, and the fastener is fastened to the base hole and the member hole, and thus the holding object is held by the resin component. Therefore, the holding object can be easily attached to the resin component.

The resin component according to a second aspect of the present disclosure may be configured such that in the first aspect, the base engaging portion includes a base blocking portion configured to block the member engaging portion engaged with the base engaging portion from moving in a direction away from the base.

In the second aspect, when the fixing member sandwiches the holding object disposed in the holding portion together with the base, the base blocking portion blocks the member engaging portion engaged with the base engaging portion from moving in the direction away from the base. Therefore, the holding object can be easily sandwiched between the fixing member and the base.

The resin component according to a third aspect of the present disclosure may be configured such that in the second aspect, the base engaging portion includes a through hole that opens in a second direction intersecting a first direction away from the base and into which the member engaging portion is inserted, and the base blocking portion includes a wall surface of the through hole.

In the third aspect, when the fixing member sandwiches the holding object disposed in the holding portion together with the base, the member engaging portion inserted into the through hole of the base engaging portion is blocked from moving in the direction away from the base. Therefore, the holding object can be easily sandwiched between the fixing member and the base.

The resin component according to a fourth aspect of the present disclosure may be configured such that in any one of the first to third aspects, the member engaging portion includes a member blocking portion configured to block the member engaging portion engaged with the base engaging portion from moving in an engagement release direction, which is a direction in which the engagement is released.

According to the fourth aspect, the member engaging portion includes a portion that blocks the member engaging portion engaged with the base engaging portion from moving in the engagement release direction. Accordingly, an operation for connecting the fixing member to the base can be performed in a state where the member engaging portion and the base engaging portion are engaged with each other. Therefore, the operation is easily performed.

The resin component according to a fifth aspect of the present disclosure may be configured such that in the fourth aspect, the base engaging portion includes a base blocking portion configured to block the member engaging portion engaged with the base engaging portion from moving in a direction away from the base, and the member blocking portion extends to engage with the base blocking portion when the member engaging portion moves in the engagement release direction.

According to the fifth aspect, the base engaging portion includes a portion that blocks the member engaging portion engaged with the base engaging portion from moving in the direction away from the base, and the member engaging portion includes a portion that blocks the member engaging portion engaged with the base engaging portion from moving in the engagement release direction. Accordingly, the release of the engagement between the member engaging portion and the base engaging portion and the release of the holding of the holding object are less likely to occur. Therefore, it is easy to attach the holding object to the resin component.

The resin component according to a sixth aspect of the present disclosure may be configured such that in the fifth aspect, the base engaging portion includes a through hole that opens in a second direction intersecting a first direction away from the base and into which the member engaging portion is inserted, the base blocking portion includes a wall surface of the through hole, and the engagement release direction is a direction in which the member engaging portion inserted into the through hole is pulled out from the through hole.

According to the sixth aspect, the member engaging portion inserted into the through hole of the base engaging portion is blocked from coming out of the through hole and releasing the engagement. Further, the member engaging portion inserted into the through hole is blocked from moving in the direction away from the base. Therefore, it is easy to attach the holding object to the resin component.

The resin component according to a seventh aspect of the present disclosure may be configured such that in any one of the first to sixth aspects, the base engaging portion has a frame shape that opens in a second direction intersecting a first direction away from the base and surrounds a through hole into which the member engaging portion is inserted, and the member engaging portion has a hook shape that is hooked to a frame of the base engaging portion from inside the through hole.

According to the seventh aspect, it is easy to engage the hook-shaped member engaging portion with the frame-shaped base engaging portion. The hook-shaped portion of the member engaging portion can also function as a member blocking portion, and the frame-shaped portion of the base engaging portion can also function as a base blocking portion.

The resin component according to an eighth aspect of the present disclosure may be configured such that in any one of the first to seventh aspects, the holding portion is located between the base engaging portion and the base hole, and the fixing member includes a fitting portion fitted to the holding portion from inside between the member engaging portion and the member hole.

According to the eighth aspect, the fixing member is positioned with respect to the base by fitting the fitting portion to the holding portion. Therefore, the fixing member can be easily connected to the base.

The resin component according to a ninth aspect of the present disclosure may be configured such that in the eighth aspect, the holding portion includes a fitting wall surface located between the base engaging portion and the base hole and facing the base engaging portion, the holding portion extends from the fitting wall surface to the base engaging portion, and the fitting portion has a shape fitted to the base engaging portion and the fitting wall surface between the base engaging portion and the fitting wall surface.

According to the ninth aspect, since the base engaging portion functions as a part of the holding portion, the structure of the holding portion can be simplified and made compact.

A vehicle according to a tenth aspect of the present disclosure includes: the holding object; and the resin component according to any one of the first to ninth aspects. According to the tenth aspect, the same effects as those of the resin component according to an aspect of the present disclosure can be achieved.

The vehicle according to an eleventh aspect of the present disclosure may be configured such that in the tenth aspect, the vehicle is a motorcycle, the vehicle includes a vehicle body frame, a front wheel, a front fork supported by the vehicle body frame and connected to the front wheel, and a brake device mounted on the front wheel, the resin component is a fork guard mounted on the front fork and configured to protect the front fork, and the holding object is a brake line extending from the brake device. According to the eleventh aspect, the resin component can be applied to the fork guard.

Numbers such as ordinal numbers and quantities used in the present specification are all examples for specifically describing the technique of the present disclosure, and the present disclosure is not limited to the exemplified numbers. The connection relation between the components is exemplified for specifically describing the technique of the present disclosure, and the connection relation for implementing the functions of the present disclosure is not limited thereto.

Since the scope of the present disclosure is defined by the appended claims rather than the description of the specification so that the present disclosure can be implemented in various forms without departing from the scope of the essential features thereof, the exemplary embodiments and modifications are exemplary and not restrictive. All modifications within the claims and the scope thereof or equivalents within the claims and the scope thereof are intended to be included in the claims.

What is claimed is:

1. A resin component comprising:
a resin main body to be mounted on a vehicle;
a base including a holding portion configured to dispose a holding object, the base being integrated with the main body;
a fixing member connected to the base in a state where the holding object located in the holding portion is sandwiched between the base and the fixing member; and
a fastener configured to fix the base and the fixing member to each other, wherein
the base includes a base engaging portion with which the fixing member is engaged and a base hole through which the fastener is inserted,
the fixing member includes a member engaging portion with which the base engaging portion is engaged and a member hole through which the fastener is inserted, and
in a state where the fixing member and the base are connected to each other, the member engaging portion is engaged with the base engaging portion, and in a state where the fastener is inserted into the member hole and the base hole, the fastener fixes the fixing member and the base to each other.

2. The resin component according to claim 1, wherein
the base engaging portion includes a base blocking portion configured to block the member engaging portion engaged with the base engaging portion from moving in a direction away from the base.

3. The resin component according to claim 2, wherein
the base engaging portion includes a through hole that opens in a second direction intersecting a first direction away from the base and into which the member engaging portion is inserted, and
the base blocking portion includes a wall surface of the through hole.

4. The resin component according to claim 1, wherein
the member engaging portion includes a member blocking portion configured to block the member engaging portion engaged with the base engaging portion from moving in an engagement release direction, which is a direction in which the engagement is released.

5. The resin component according to claim 4, wherein
the base engaging portion includes a base blocking portion configured to block the member engaging portion engaged with the base engaging portion from moving in a direction away from the base, and
the member blocking portion extends to engage with the base blocking portion when the member engaging portion moves in the engagement release direction.

6. The resin component according to claim 5, wherein
the base engaging portion includes a through hole that opens in a second direction intersecting a first direction away from the base and into which the member engaging portion is inserted,
the base blocking portion includes a wall surface of the through hole, and
the engagement release direction is a direction in which the member engaging portion inserted into the through hole is pulled out from the through hole.

7. The resin component according to claim 1, wherein
the base engaging portion has a frame shape that opens in a second direction intersecting a first direction away from the base and surrounds a through hole into which the member engaging portion is inserted, and
the member engaging portion has a hook shape that is hooked to a frame of the base engaging portion from inside the through hole.

8. The resin component according to claim 1, wherein
the holding portion is located between the base engaging portion and the base hole, and
the fixing member includes a fitting portion fitted to the holding portion from inside between the member engaging portion and the member hole.

9. The resin component according to claim 8, wherein
the holding portion includes a fitting wall surface located between the base engaging portion and the base hole and facing the base engaging portion,
the holding portion extends from the fitting wall surface to the base engaging portion, and
the fitting portion has a shape fitted to the base engaging portion and the fitting wall surface between the base engaging portion and the fitting wall surface.

10. The resin component according to claim 9, wherein
a length of the fitting portion is equal to or greater than a distance between the fitting wall surface and the base engaging portion.

11. A vehicle comprising:
the holding object; and
the resin component according to claim 1.

12. The vehicle according to claim 10, wherein
the vehicle is a motorcycle,
the vehicle includes:
a vehicle body frame;
a front wheel;
a front fork supported by the vehicle body frame and connected to the front wheel; and
a brake device mounted on the front wheel,
the resin component is a fork guard mounted on the front fork and configured to protect the front fork, and
the holding object is a brake line extending from the brake device.
